(19) United States
(12) Patent Application Publication
(10) Pub. No.: US 2004/0078311 A1
(43) Pub. Date: Apr. 22, 2004

(54) System and method for automated binning and automatic data entry of centralized returns

(76) Inventor: Timothy Robinson, Herndon, VA (US)

Correspondence Address: ROBERTS ABOKHAIR & MARDULA, SUITE 1000, 11800 SUNRISE VALLEY DRIVE, RESTON, VA, 20191, US

(21) Appl. No.: 10/277,017

(22) Filed: Oct. 21, 2002

(51) Int. Cl. G06F 17/60

(52) U.S. Cl. 705/35

(57) ABSTRACT

Returned checks are collected at a central return (CR) bank. The CR bank passes a batch of returned checks through a binning machine that is connected to a central database. For each check in the batch, the binning machine scans the magnetic ink character recognition (MICR) on the check, scans the check using an optical character recognition (OCR) reader, captures a digital image of the check, and sends this information about the returned check to the central database in the form of a query. The central database matches the returned check information to check identifying information in the database, which was captured at the time of the original transaction, and combines the check identifying information and the return check information into a returned check file. It then returns a copy of the returned check file to the binning machine. The binning machine uses information from the returned check file to bin the check by merchant, doing likewise for each check in the batch. Once the checks have been binned, each check has a corresponding electronic record comprising its returned check file. All electronic records belonging to a specific merchant are forwarded to that merchant for check reimbursement collection.

### FIELD OF THE INVENTION

This present invention relates generally to the automatic processing of returned checks. More particularly, the present invention provides a system and method for associating electronic data files with check transactions to allow automated binning and automatic data entry of checks returned to a centralized returns bank.

### BACKGROUND OF THE INVENTION

Centralized check return systems provide commercial payees (merchants) with an alternative method of dealing with returned checks written by payors (typically consumers, but may include other merchants). These checks are returned for various reasons but the returns are usually related to insufficient funds or a closed account. The centralized check return system directs returned checks to a centralized returns bank (CR Bank) rather than having such checks returned to the merchant's bank. Merchants using a centralized check returns bank avoid fees associated with returned check transactions that would normally be charged by the merchant bank. Once a CR Bank processes the returned checks, data relating to the returned checks is sent to the merchant.

Checks received by a CR Bank comprise checks from various merchants. The returned checks must be sorted, or binned, according to merchant so that the number of checks and the total amount of the returned checks per merchant may be tallied and debited from each merchant accordingly. Once these figures are determined, the CR Bank debits the appropriate merchant's account for the total amount of returned checks in the particular batch. (For the purposes of this application, a merchant's account comprises a specific account at the CR Bank or other financial accounts responsible for the merchant's returned checks.) Money debited from the merchant's account is used to offset the debit from the Federal Reserve Bank, or other check clearing system (the “FED”), for the returned checks.

In the current centralized returns system, if a check is returned (usually due to insufficient funds), it is ultimately sent to a centralized returns bank for collection attempts. The CR Bank regularly receives large stacks of returned checks that they must manually sort according to the payee. Once these checks are physically sorted, the CR Bank must tally the amount of these checks per merchant. This tally may be done manually or may be done electronically by systems that scan check MICR lines for check amount information. Once tallied, the checks must then be sent to a data entry agency where additional check data (such as amount of the check, merchant information, transaction data, etc.) may be electronically entered into a database and this information may be used to further process the check. Additionally, once the CR Bank has determined a total of the number of checks and the amounts of those checks for each merchant within a batch, data entry processors must manually enter check data, such as check presenter information and check amount, into the financial system. Manually sorting these checks and then entering the data contained on them is both time and labor intensive, costing as much as of 70 cents per check. Additionally, the manual process offers the opportunity for errors to be introduced during the sorting and data entry stages adding additional costs associated with correcting such errors.

What is needed is an automated system and method for sorting returned checks and for entering check data related to a returned check.

### SUMMARY OF THE INVENTION

An embodiment of the present invention is an automated check sorting and data entry system for centralized check returns.

It is therefore, an object of the present invention to create a system for automatically sorting returned checks.

It is yet another object of the present invention to create an electronic data file that may be associated with check transactions.

It is still a further object of the present invention to create a system for automatically entering returned check information into the financial system.

It is another object of the present invention to reduce the cost associated with the time and labor for manually processing returned checks.

It is yet another object of the present invention to eliminate the potential errors resulting from human data entry of multiple data fields.

These and other objects of the present invention will become apparent to those skilled in the art by a review of the specification that follows. An embodiment of the present invention is a system and method for automatically processing checks returned in a centralized check return system. In this embodiment, a merchant captures check identifying information at the point of sale and sends the check identifying information to a central database. This information is at least a check's MICR information, which is typically a magnetically encoded number comprising a record of the payor's bank (the bank the check is written on) in the form of an ABA number, the account the check is written from in the form of an account number, and the check sequence number. The combination of these three data elements creates a unique number that may be used for transaction tracking purposes. While this information identifies the check and the payor, it does not identify the merchant. The MICR info may additionally comprise the check amount, which is encoded into the already existing MICR information.

Returned checks are collected by a CR Bank. The CR Bank passes a batch of returned checks through a binning machine with connection to the central database. The binning machine scans the magnetic ink character recognition (MICR) on the check, scans the check using an optical character recognition (OCR) reader, and captures a digital image of the check and sends this returned check information to the central database in the form of a query.

The central database locates the check identifying information that matches the returned check information, combines the check identifying information and the return check information into a returned check file, and sends a copy of the returned check file to the binning machine. The binning machine uses information from the returned check file to bin each check by merchant and proceeds to the next check. Once the checks have been binned, each check has a corresponding electronic record comprising its returned check file. All electronic records belonging to a specific merchant are forwarded to that merchant for check reimbursement collection. Should the CR Bank deem additional check data entry is needed such information may be pulled from the OCR read of the check. Additionally, there is no need to return the physical checks to the merchant since a digital copy of the check is included in the returned check file.

### BRIEF SUMMARY OF THE DRAWINGS

Additional aspects and advantages of the present invention will be apparent in the following detailed description read in conjunction with the accompanying drawing figures.

FIG. 1 illustrates a general architecture overview of a system for automatic processing of centrally returned checks.

FIG. 2 illustrates a flowchart of a returned check flow through a system for automatic processing of centrally returned checks.

FIG. 3 illustrates a flowchart of a returned check processed with automated binning, electronic data entry, and electronic check delivery in a system for automatic processing of centrally returned checks.

FIG. 4 illustrates a flowchart of a returned check processed with automated binning, partial electronic data entry, and electronic check delivery in a system for automatic processing of centrally returned checks.

FIG. 5 illustrates a flowchart of a returned check processed with automated binning, partial electronic data entry, and manual check delivery in a system for automatic processing of centrally retuned checks.

### DETAILED DESCRIPTION OF EMBODIMENTS

An embodiment of the present invention is a system and method for automatically sorting and processing returned checks.

The present invention represents an advantage above the prior art because it allows CR Banks to electronically (instead of manually) process checks that have been physically returned. The electronic processing relies on automated binning and automated data entry methods. This automation of processing returned check saves the CR Bank time and money.

In the prior art centralized returns system, if a check is returned (usually due to insufficient funds), it is ultimately sent to a centralized returns bank for collection attempts. The centralized returns bank regularly receives large stacks of returned checks that they must manually sort according to merchant (payee). Once these checks are physically sorted, the CR Bank must tally the amount of these checks per merchant. The checks must then be sent to a data entry agency where additional check data (such as merchant information, transaction data, etc.) may be electronically entered into a database and this information may be used to further process the check.

The present invention automates this process, allowing the centralized returns bank to simply run the returned checks through a binning machine with connection to a central database. The binning machine MICR scans, OCR scans, and scans a digital image of the check. This information is sent to the invention's central database. The central database includes records of check data, which have been collected and stored by the merchant at the original presentment of the check. This check data is matched to the returned check data and all related check information is combined into one electronic file for that check. A copy of this file is returned to the binning machine. The binning machine uses information from that file to bin the check by merchant and proceeds to the next check. Once the checks have been binned, each check has a corresponding electronic record. All electronic records belonging to a specific merchant are forwarded to that merchant for check reimbursement collection. Should the centralized returns bank deem additional check data entry is needed, this information may be pulled from the OCR read of the check. Additionally, there is no need to return the physical checks to the merchant since a digital copy of the check is included in the check's electronic file. The CR Bank may store the physical checks in the event they are needed further.

The present invention allows centralized processing systems to cut the fee of the data entry processor entirely, and allows the centralized returns bank to speed the process of sorting the returned checks by merchant.

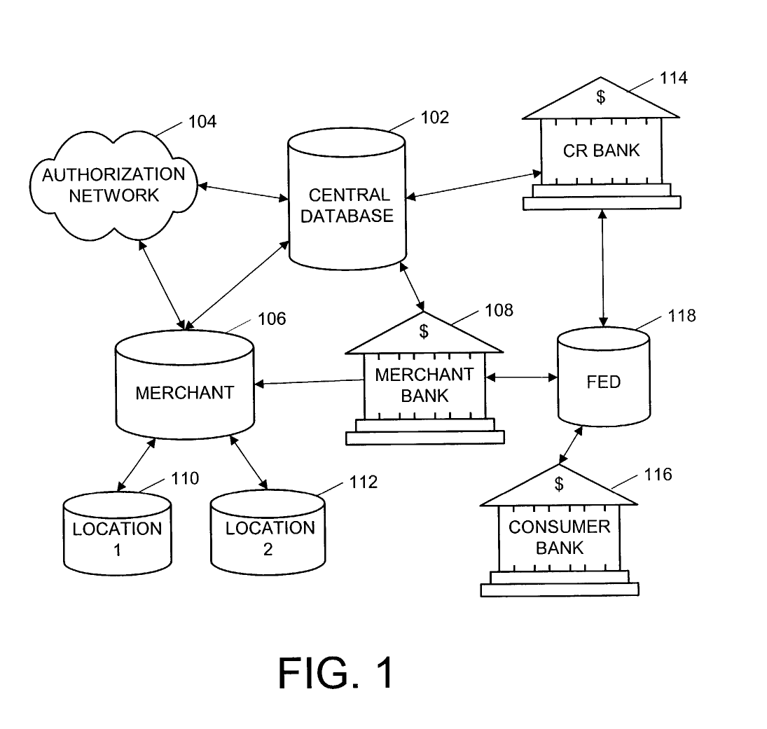

Referring to FIG. 1, a general architecture of an embodiment of the present invention is illustrated. One aspect of the invention's system is a central database 102. A merchant sends check identifying information captured at the point of sale to central database 102. Central database 102 also receives returned check information from CR Bank 114. Connected to the central database 102 via a connection means, such as, but not limited to, the Internet, is a merchant database 106, wherein a local record of returned check information is stored by the merchant, and which is connected to merchant locations 110 and 112, a merchant bank 108, an authorization network 104; a CR Bank 114, the FED 118, which is also connected to the CR Bank 114, the merchant bank 108, and a consumer bank 116. As illustrated in FIG. 1, central database 102 is a separate entity, however this is not meant as a limitation. In an alternate embodiment, central database 102 may reside at the CR Bank 114. As would be apparent to those skilled in the art of the present invention, a plurality of merchant databases, merchant banks, CR banks and consumer banks may be utilized by the present invention without of departing from its scope.

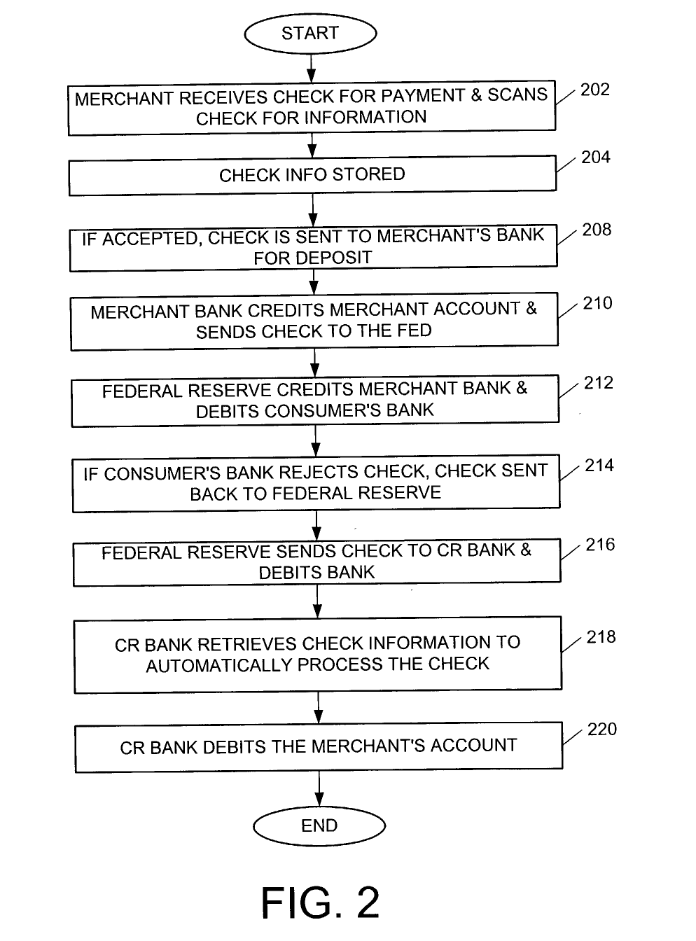

Referring to FIG. 2, the general flow of a returned check is illustrated. The check flow begins at the merchant when the merchant receives a check from a consumer in order to pay for a purchase. When the merchant receives the check, the check is scanned using a MICR reader to obtain the MICR encoded information on the check 202 in electronic form.

In another embodiment, the scanned information is first sent to an authorization network that approves or declines the check before the information is sent to the central database.

In another embodiment of the present invention, the merchant enters additional check identifying information. By way of example and not as a limitation, the merchant enters transaction information, a merchant identification number (MID), a store number, a terminal identification number (TID), a clerk ID, time information, and the presenter's identification information. This information may be entered automatically, manually, or via electronic scan. Electronic scans encompass a wide variety of ways to read data, including (by way of example and not as a limitation) a MAG stripe scan, a bar code scan, an OCR scan, and a digital scan as alternatives that can be utilized for practice of the present invention. As those skilled in the art of the present invention will recognize, other check identifying information may be captured and data capture methods used without departing from the scope of the present invention. Check identifying information is sent to central database 102 (see FIG. 1) for storage 204.

Upon completion of the transaction, the merchant stamps or franks the check with the CR Bank information and sends the check to the merchant bank for deposit 208. The merchant bank credits the merchant's account for the amount of the check and sends the check to the FED 210. The FED comprises any type of check clearing system, such as, but not limited to, the Federal Reserve or other bank-to-bank system. The FED credits the merchant bank the amount equal for which the check was written and debits the same amount from the consumer bank 212. If the consumer bank rejects the check, the check is returned to the FED 214. The FED then sends the rejected check to the CR Bank and debits the amount of the rejected check from CR Bank 216.

Once the CR Bank receives the rejected check, the check is scanned and the acquired scanned data (the returned check information) is used to query the central database for the check information stored there by the merchant (the check identifying information). The central database concatenates the scanned data and the returned check information and sends concatenated data file (the returned check file) to the CR Bank. The CR Bank uses the returned check file to automatically process the check 218 and debits the merchant's account aggregate amount of all checks returned on the merchant's account 220.

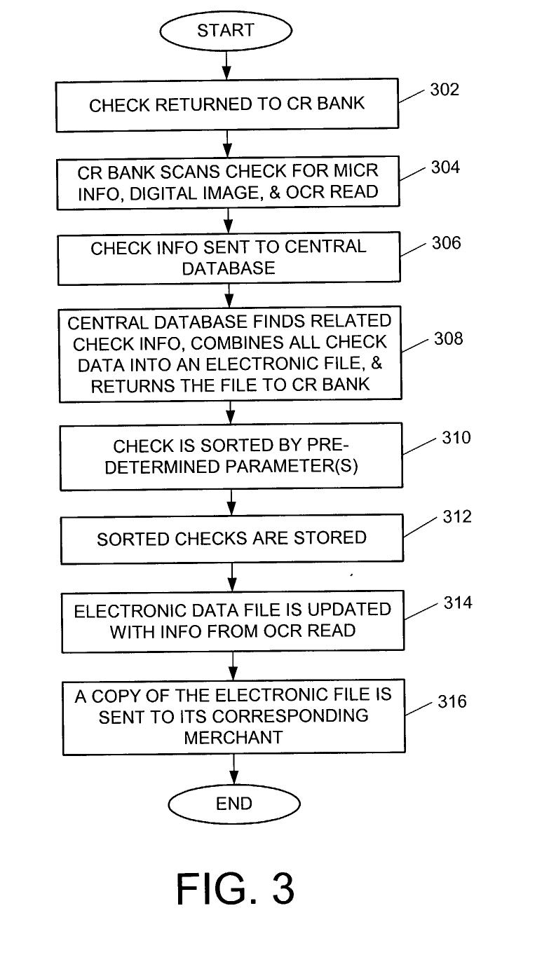

Referring to FIG. 3, the general flow of a returned check processed with automated binning, electronic data entry, and electronic check delivery is illustrated. Automated binning refers to a binning machine using electronically delivered information to sort checks into designated bins. This allows each bin of the binning machine to be temporarily assigned to a different merchant. In this process, returned check information is captured and used to query the central database for binning related information, and the check is binned according to select information the central database returns.

In one embodiment, the automated binning machine has a minimum of two bins, one for checks found in the central database and one for checks not found. In another embodiment, the binning machine designates one bin per merchant. However, if the binning machine has a limited number of bins, the automated binning process may be conducted in two or more steps, wherein the checks are binned according to increasingly more detailed groupings. Electronic data entry refers to information electronically obtained being used to automatically fill in data fields. The meaning intended in this disclosure is that electronic check delivery refers to an image of the check being returned to the merchant rather than the physical check being returned. That meaning is not inconsistent with leaving open the option of delivering the physical check to the merchant if such an additional action is desired, e.g., in the event the original paper document needs to be produced at trial.

Referring to FIG. 3, a check is returned to the CR Bank 302. The CR Bank captures the returned check information. In an embodiment of the present information, capturing the returned check information comprises scanning the check for MICR information, creating a digital image of the check, and reading the check using an OCR reader 304. In another embodiment according to the present invention, the MICR scanner also marks or sprays the back of the check with a batch number. In yet another embodiment, in addition to, or in lieu of, the batch number, the date and an item number are added to the back of the check. This information is used for further check tracking.

The CR Bank sends the returned check information to the central database 306 where the returned check information is matched with, and combined with, the check identifying information previously sent to the database by the merchant, and returned to the CR Bank 308.

The CR Bank sorts the returned check files by at least one pre-determined parameter 310. In one embodiment of the present invention, the pre-determined parameter used to sort the check is the merchant identification number. Once the automated check sorting is complete, checks are stored 312. The electronic file of the check is updated 314 with information obtained in the OCR 304. Optionally, the check image and check data may be manually reviewed for data entry accuracy. Copies of the electronic returned check files are sent to their corresponding merchant database 316.

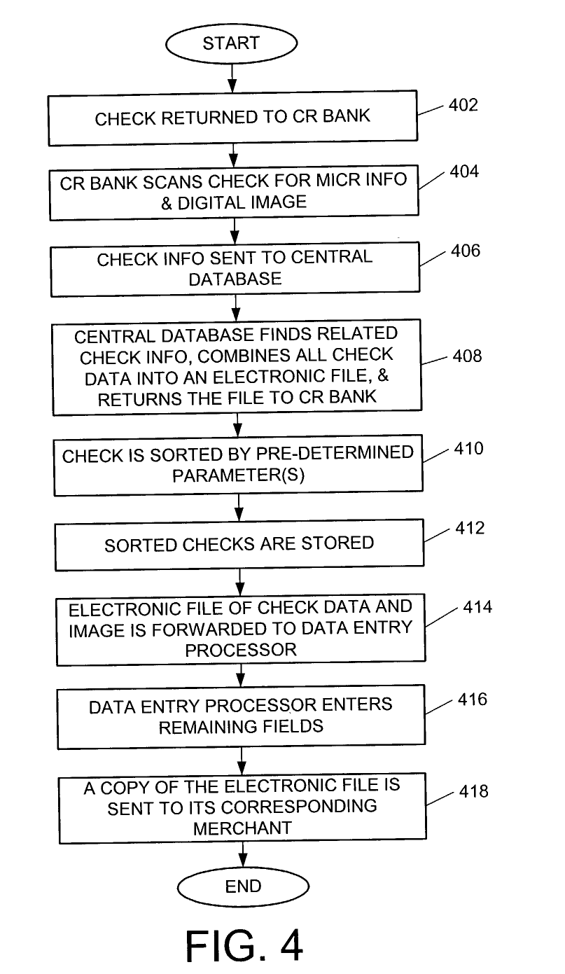

Referring to FIG. 4, the general flow of a returned check processed with automated binning, partial electronic data entry, and electronic check delivery is illustrated.

A check is returned to the CR Bank 402. The CR Bank captures the returned check information. In an embodiment of the present information, capturing the returned check information comprises scanning the check for MICR information and creating a digital image of the check 404. In another embodiment according to the present invention, the MICR scanner also marks or sprays the back of the check with a batch number. In yet another embodiment, in addition to, or in lieu of, the batch number, the date and an item number are added to the back of the check. This information is used for further check tracking.

The CR Bank sends the returned check information to the central database 406 where the returned check information is matched with, and combined with, the check identifying information previously sent to the database by the merchant, and returned to the CR Bank 408.

The CR Bank sorts the returned check files by at least one pre-determined parameter 410. In one embodiment of the present invention, the pre-determined parameter used to sort the check is the merchant identification number. Once the automated check sorting is complete, checks are stored 412. The electronic returned check file is forwarded to at least one data entry processor 414. The data entry processor(s) retrieves any additional information from the digital image of the check and manually enters it into the returned check file 416. Copies of the electronic returned check files are sent to their corresponding merchant database 418.

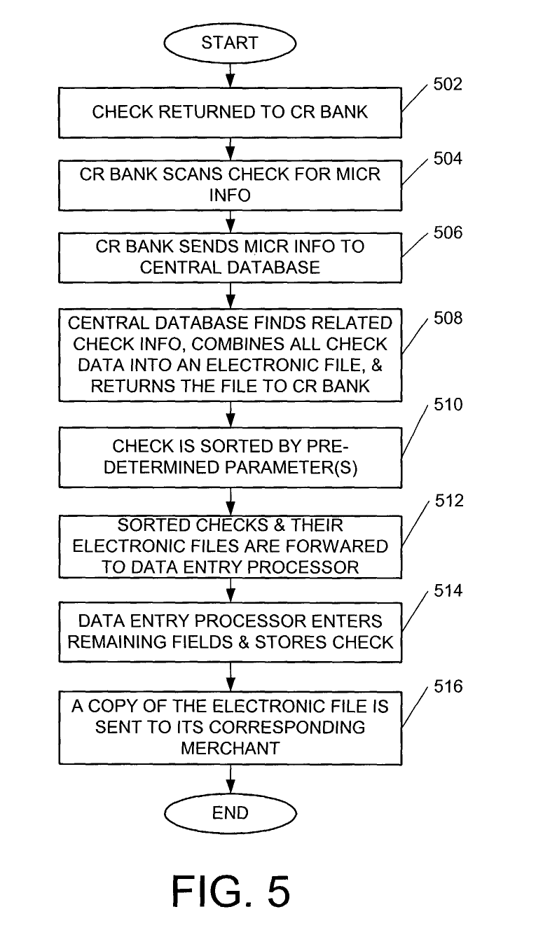

Referring to FIG. 5, the general flow of a returned check processed with automated binning, partial electronic data entry, and manual check delivery is illustrated. Manual check delivery refers to the physical checks being delivered.

A check is returned to the CR Bank 502. The CR Bank captures the returned check information. In an embodiment of the present information, capturing the returned check information comprises scanning the check for MICR information 504. In another embodiment according to the present invention, the MICR scanner also marks or sprays the back of the check with a batch number. In yet another embodiment, in addition to, or in lieu of, the batch number, the date and an item number are added to the back of the check. This information is used for further check tracking.

The CR Bank sends the returned check information to the central database 506 where the returned check information is matched with, and combined with, the check identifying information previously sent to the database by the merchant, and returned to the CR Bank 508.

The CR Bank sorts the returned check files by at least one pre-determined parameter 510. In one embodiment of the present invention, the pre-determined parameter used to sort the check is the merchant identification number. Once the automated check sorting is complete, the check and its corresponding electronic returned check file are forwarded to the data entry processor 512. The data entry processor updates the check's electronic returned check file with information printed on the check 514. The check and a copy of its electronic returned check file are sent to their corresponding merchant database 516.

In all of the above embodiments of returned check processing, one or more bins may be designated for checks with information not found in the central database. The checks sorted into this bin would be processed manually.

Another embodiment of the present invention is a check plucking method, wherein a specific check or multiple checks are separated from a stack of checks. In this embodiment, the MICR information of the desired check(s) is entered into the binning machine. This MICR data entry may be manually keyed or entered automatically through an electronic file. The stack of checks is then binned according to desired check MICR information and non-desired check MICR information.

A system and method for automatically processing checks returned to a centralized returns bank has been illustrated. As described herein, the system and method for automatically processing checks returned to a centralized returns bank significantly reduces the time and resources needed to process returned checks. It will also be understood that the invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible.

What is claimed is:

1. In a banking network a method for sorting a plurality of returned checks, the method comprising:
capturing electronically check identifying information upon proffer of a check for payment to a payee;
storing the check identifying information in a database;
obtaining from the database the check identifying information of a plurality of returned checks; and
sorting a plurality of returned checks based on the check identifying information so as to associate each of the plurality of returned checks with a payee.

2. The method according to claim 1, wherein the check identifying information comprises an ABA number, an account number, and a check sequence number.

3. The method according to claim 2, wherein the check identifying information comprises information chosen from the group consisting of a merchant identification number (MID), a store number, a terminal identification number (TID), a clerk ID, time information, and a presenter's identification information.

4. The method according to claim 3, wherein capturing a presenter's identification information comprises a means chosen from the group consisting of an OCR scan, a digital scan, a MAG stripe scan, and a bar code scan.

5. The method according to claim 1, wherein the check identifying information comprises an ABA number, an account number, a check sequence number, and a check amount.

6. The method according to claim 1, wherein capturing the check identifying information comprises scanning the check using a MICR reader to obtain the MICR encoded data.

7. The method according to claim 1, wherein capturing the check identifying information comprises reading information from the check using a device chosen from the group consisting of an OCR scan and a digital scan.

8. The method according to claim 1, wherein obtaining from the database the check identifying information of a plurality of returned checks comprises:
obtaining returned check data from a plurality of returned checks wherein the returned check data comprises MICR encoded data;
sending the returned check data for one of the plurality of returned checks to the database; and
associating the returned check data for the one of the plurality of returned checks with the check identifying data stored in the database.

9. The method according to claim 1, wherein checks without check identifying information in a database are not sorted.

10. In a banking network a method for sorting a plurality of returned checks, the method comprising:
obtaining from an electronic file the identifying information of a plurality of returned checks; and
sorting the plurality of returned checks based on the check identifying information.

11. In a banking network a system for sorting a plurality of returned checks, the system comprising:
a means for entering check identifying information into the system concerning a plurality of checks;
at least one database for storing the check identifying information;
a means for entering check identifying information into the system concerning a plurality of returned checks; and
a means for matching the check identifying information concerning the plurality of checks, stored in the at least one database, with the check identifying information concerning the plurality of returned checks so as to associate each of the plurality of returned checks with a payee.
